(19) United States
(12) Patent Application Publication
(10) Pub. No.: US 2025/0340066 A1
(43) Pub. Date: Nov. 6, 2025

(54) INK JET RECORDING METHOD, INK JET RECORDING APPARATUS AND SET OF AQUEOUS INK AND AQUEOUS REACTION LIQUID

(71) Applicant: CANON KABUSHIKI KAISHA, Tokyo (JP)

(72) Inventors: NAO ISHIJIMA, Kanagawa (JP); YUKO NEGISHI, Tokyo (JP); EIICHI NAKATA, Kanagawa (JP)

(21) Appl. No.: 19/196,983

(22) Filed: May 2, 2025

(30) Foreign Application Priority Data
May 2, 2024 (JP) 2024-074804
Apr. 28, 2025 (JP) 2025-074251

(51) Int. Cl. B41J 2/21; B41J 11/00; B41M 5/00; B41M 7/00; C09D 11/322; C09K 11/54

(52) U.S. Cl. CPC B41J 2/2114; B41J 11/0022; B41M 5/0017; B41M 7/009; C09D 11/322; C09K 11/54

(57) ABSTRACT

An aqueous ink containing a pigment, a resin particle and a water-soluble organic solvent as well as an aqueous reaction liquid that reacts with the aqueous ink are ejected from an ink jet recording head and applied to a non-absorbent recording medium to record an image. This ink jet recording method includes a gas blowing step of blowing gas to the recording medium to reduce liquid components, wherein the aqueous reaction liquid contains a first reaction liquid, and a second reaction liquid having a reaction strength with the aqueous ink lower than that of the first reaction liquid, and the image includes a low gloss area formed by applying the first reaction liquid and the aqueous ink and a high gloss area formed by applying the second reaction liquid and the aqueous ink.

### BACKGROUND OF THE INVENTION

### Field of the Invention

The present invention relates to an ink jet recording method, an ink jet recording apparatus and a set of an aqueous ink and an aqueous reaction liquid.

### Description of the Related Art

In recent years, the ink jet recording method has been increasingly used in the field of signs and displays, such as recording posters and large-sized advertisements. One of the characteristics of the ink jet recording apparatus used in this field is that the recording area is wider than that of a home-use ink jet recording apparatus. In addition, since it is necessary to attract attention, ink capable of recording an image with high color development is required. Furthermore, an image with partially controlled glossiness is expected to have noticeability because the impression is emphasized by the gloss difference.

In the field of signs and displays, a polyvinyl chloride sheet, a polyethylene terephthalate (PET) sheet or the like is often used as the recording medium. These are recording media that do not have, or hardly have, an aqueous ink absorbing layer on the recording surface of the recording medium, and are so-called non-absorbent recording media (recording media having no absorbency for aqueous ink) or low-absorbent recording media (recording media having low absorbency for aqueous ink). It is required that a high-quality image with suppressed bleeding can be recorded even on such a non-absorbent recording medium or a low-absorbent recording medium. In order to meet such demands, it is necessary to rapidly thicken and fix the ink applied to the recording medium and to control the ink so that it is not repelled on the recording medium.

As a method of recording an image on the above-mentioned non-absorbent recording medium or low-absorbent recording medium (hereinafter, these are collectively referred to as “non-absorbent recording medium”), a solvent-based ink containing an organic solvent as a main component, a curable ink containing a polymerizable monomer or the like is used. However, in recent years, from the viewpoint of reducing environmental load and improving safety, the need for a recording method using an aqueous ink is increasing.

As a method of recording an image on a non-absorbent recording medium using an aqueous ink, for example, there is a method of evaporating moisture in the ink on the surface of the recording medium. This method is advantageous in terms of running cost, but productivity is likely to decrease as the recording speed decreases. For this reason, a method of using a reaction liquid that aggregates components in the ink in combination with the ink has been proposed. For example, a recording method using a first reaction liquid containing a flocculant that aggregates components in a first ink and a second reaction liquid containing a flocculant that aggregates components in a second ink has been proposed (Japanese Patent Application Laid-Open No. 2015-147405).

### SUMMARY OF THE INVENTION

The present invention is directed to providing an ink jet recording method capable of recording an image on a low- to non-absorbent recording medium, wherein the image includes a low gloss area having excellent abrasion resistance and a high gloss area having suppressed bleeding, the image having a glossiness that is partially controlled. The present invention is also directed to providing an ink jet recording apparatus used in this ink jet recording method, and a set of an aqueous ink and an aqueous reaction liquid.

That is, according to one aspect of the present invention, there is provided an ink jet recording method for recording an image by ejecting an aqueous ink containing a pigment, a resin particle and a water-soluble organic solvent as well as an aqueous reaction liquid that reacts with the aqueous ink from an ink jet recording head and applying them to a recording medium, the method including a gas blowing step of blowing gas to the recording medium to reduce liquid components, wherein the aqueous reaction liquid contains a first reaction liquid, and a second reaction liquid having a reaction strength with the aqueous ink lower than that of the first reaction liquid, the image includes a low gloss area formed by applying the first reaction liquid and the aqueous ink and a high gloss area formed by applying the second reaction liquid and the aqueous ink, and the recording medium has a water absorption of 10 mL/m² or less from start of contact to 30 msec^{1/2} in a Bristow method.

Further features of the present invention will become apparent from the following description of exemplary embodiments with reference to the attached drawings.

### BRIEF DESCRIPTION OF THE DRAWINGS

FIG. 1 is a perspective view schematically showing an embodiment of an ink jet recording apparatus of the present invention.

FIG. 2 is a side view schematically showing an embodiment of an ink jet recording apparatus of the present invention.

FIG. 3 is a schematic view showing an embodiment of an ink jet recording apparatus of the present invention.

### DESCRIPTION OF THE EMBODIMENTS

Hereinafter, the present invention will be described in more detail with reference to preferred embodiments. In the present invention, when a compound is a salt, the salt is present in a dissociated state as ions in the ink and reaction liquid, but for convenience, it is expressed as “containing a salt.” In addition, aqueous ink and reaction liquid for ink jet may be simply referred to as “ink” and “reaction liquid,” respectively. Physical property values are values at room temperature (25° C.) and normal pressure (1 atmosphere) unless otherwise specified. The terms “(meth)acrylic acid” and “(meth)acrylate” mean “acrylic acid and methacrylic acid” and “acrylate and methacrylate,” respectively.

The present inventors examined images recorded on a non-absorbent recording medium by the recording method proposed in Japanese Patent Application Laid-Open No. 2015-147405, which does not describe controlling partially the glossiness of images. As a result, although the glossiness could be partially controlled to some extent, it was found that bleeding in the high gloss area in the image was not always suppressed among the high gloss area and the low gloss area in the image. It was also found that the abrasion resistance of the low gloss area was not sufficient, and there was room for improvement.

Therefore, the present inventors diligently studied an ink jet recording method capable of recording an image on a low- to non-absorbent recording medium, wherein the image includes a low gloss area having excellent abrasion resistance and a high gloss area having suppressed bleeding, and the image has a glossiness that is partially controlled, and as a result, arrived at the present invention.

The reaction strength of the reaction liquid with the ink is relatively determined by the magnitude of the viscosity of the mixture obtained by mixing the reaction liquid and the ink. Specifically, the viscosity (Pa's) of a mixture obtained by mixing 100 parts by mass of ink and 7 parts by mass of reaction liquid is compared with the viscosity (Pa·s) of another mixture obtained by mixing 100 parts by mass of the same ink and 7 parts by mass of another reaction liquid. In this case, it can be determined that the reaction strength of this reaction liquid is higher than the reaction strength of the other reaction liquid. The mass ratio of the reaction liquid and the ink mixed above is assumed to be the situation when the reaction liquid and the ink come into contact on the recording medium.

The present inventors first investigated the reason why the quality of the high gloss area and the abrasion resistance of the low gloss area in an image recorded using two types of reaction liquids and ink were insufficient. In order to enhance the glossiness of an image, it is necessary to reduce the reaction strength between the ink and the reaction liquid and to lower the height of the formed dots. By lowering the height of the dots, the unevenness of the image surface can be reduced, and the glossiness of the image can be enhanced. On the other hand, when the reaction strength between the ink and the reaction liquid is reduced, the pinning ability of the formed dots is reduced, and the image quality is likely to deteriorate.

As a result of further studies, the present inventors have found that providing a gas blowing step in which gas is blown to a recording medium to which a reaction liquid and ink have been applied, in order to reduce liquid components (including water and water-soluble organic solvents in the reaction liquid and ink) on the recording medium, and thus arrived at the present invention. By providing the gas blowing step, thickening due to drying of the reaction product of the ink and the reaction liquid can be promoted, and the quality of the recorded image can be improved.

Specifically, the ink jet recording method of the present invention is a method of recording an image by ejecting an ink containing a pigment, a resin particle and a water-soluble organic solvent as well as an aqueous reaction liquid that reacts with the ink from an ink jet recording head and applying them to a recording medium. The reaction liquid includes a first reaction liquid and a second reaction liquid having a reaction strength with the ink lower than that of the first reaction liquid. As described above, the ink jet recording method of the present invention includes a gas blowing step of blowing gas to the recording medium to reduce liquid components. The recorded image includes a low gloss area formed by applying the first reaction liquid and the ink, and a high gloss area formed by applying the second reaction liquid and the ink.

The present inventors speculate the mechanism by which an image can be recorded on a low- to non-absorbent recording medium, wherein the image includes a low gloss area having excellent abrasion resistance and a high gloss area having suppressed bleeding, and the image has a glossiness that is partially controlled, as follows.

In order to form a low gloss area having a relatively low glossiness, it is necessary to use a reaction liquid having a high reaction strength in order to increase the height of dots and increase the unevenness of the image surface. However, when the unevenness of the surface increases, the friction coefficient increases, so that the abrasion resistance is likely to decrease. On the other hand, by providing a gas blowing step of blowing gas to the recording medium to reduce liquid components, a decrease in abrasion resistance of the low gloss area can be suppressed. It is considered that by blowing gas to the surface of the recording medium to which the reaction liquid and the ink have been applied, water in the ink evaporates, the ratio of the water-soluble organic solvent increases and the minimum film-forming temperature of the resin particle decreases. It is considered that molten resin present at protruding portions of unevenness on the image surface, which is derived from the melted resin particle, is then solidified to strengthen the protruding portions and thereby improve the abrasion resistance.

### <Ink Jet Recording Method, Ink Jet Recording Apparatus and Set of Aqueous Ink and Aqueous Reaction Liquid>

The ink jet recording method of the present invention is a method of recording an image by ejecting an aqueous ink containing a pigment, a resin particle and a water-soluble organic solvent as well as an aqueous reaction liquid that reacts with the aqueous ink from an ink jet recording head and applying them to a recording medium. The ink jet recording method of the present invention includes a gas blowing step of blowing gas to the recording medium to reduce liquid components. The aqueous reaction liquid includes a first reaction liquid and a second reaction liquid having a reaction strength with the aqueous ink lower than that of the first reaction liquid. The image includes a low gloss area formed by applying the first reaction liquid and the aqueous ink, and a high gloss area formed by applying the second reaction liquid and the aqueous ink. The recording medium has a water absorption of 10 mL/m² or less from start of contact to 30 msec^{1/2} in a Bristow method.

The ink jet recording apparatus of the present invention is an apparatus used in an ink jet recording method of ejecting the above-mentioned aqueous ink and aqueous reaction liquid from an ink jet recording head and applying them to a recording medium to record an image. The ink jet recording apparatus of the present invention is an apparatus suitably used for the above recording method. It is not necessary to provide a step of irradiation with active energy rays to cure the image.

The set of the aqueous ink and the aqueous reaction liquid of the present invention is a set used in an ink jet recording method of ejecting the above-mentioned aqueous ink and aqueous reaction liquid from an ink jet recording head and applying them to a recording medium to record an image. This set is suitably used for the above recording method. The form of the set includes a set of a plurality of ink cartridges, each of which houses a plurality of inks (reaction liquids) independently, and an ink cartridge formed as an integral unit by combining a plurality of ink housing portions, each of which houses a plurality of inks (reaction liquids). The set of the present invention is not limited to the above form as long as it is configured so that the ink and the reaction liquid can be used in combination, and may be in any form.

Hereinafter, the ink jet recording method and the ink jet recording apparatus (hereinafter, also simply referred to as “recording method and recording apparatus”) of the present invention will be described in detail.

### (Ink Jet Recording Apparatus)

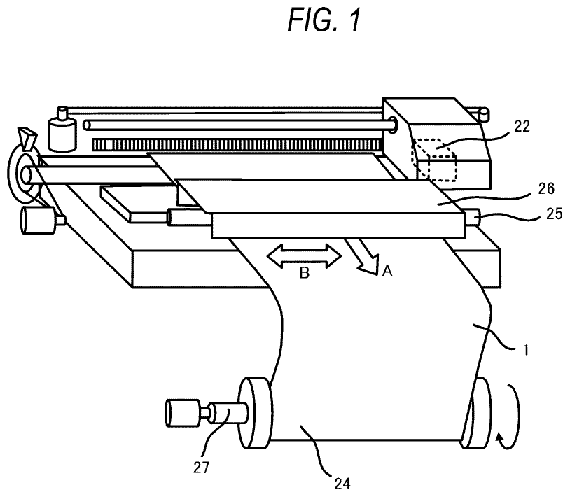

FIG. 1 is a perspective view schematically showing an embodiment of an ink jet recording apparatus of the present invention.

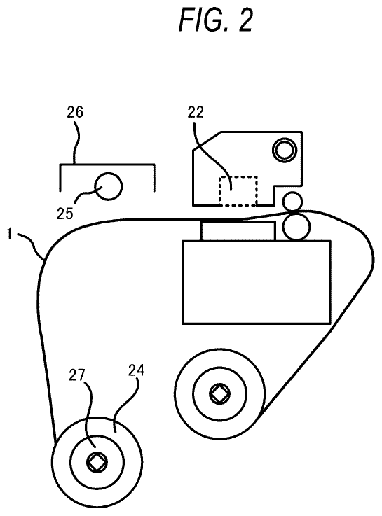

FIG. 2 is a side view schematically showing an embodiment of an ink jet recording apparatus of the present invention. As shown in FIGS. 1 and 2, the recording apparatus of the present embodiment includes an ink jet recording head 22 that ejects ink. Examples of the recording head include a recording head that ejects ink and a reaction liquid by the action of mechanical energy, and a recording head that ejects ink and a reaction liquid by the action of thermal energy. Among them, a recording head that ejects ink and a reaction liquid by the action of thermal energy is preferable. The recording head that ejects ink and a reaction liquid by the action of thermal energy is a thermal type recording head that applies an electric pulse to an electrothermal conversion element to apply thermal energy to the ink and the reaction liquid, and ejects the ink and the reaction liquid from an ejection port. This thermal recording head preferably includes a mechanism (temperature control mechanism) for heating the aqueous ink ejected from the recording head and applied to the recording medium to a predetermined temperature. When a temperature control mechanism is provided, the heating temperature of the ink ejected from the recording head is preferably 35° C. or more to 70° C. or less. Incidentally, a gas blowing device to be used for blowing gas to the recording medium 1 to reduce liquid components in the gas blowing step described later can be provided though it is not depicted in FIG. 1 and FIG. 2 specifically. The gas blowing device is disposed along the conveyance route. The gas blowing device can be provided either on the upstream side or on the downstream side relative to the recording head 22 in the conveying direction.

### [Gas Blowing Step]

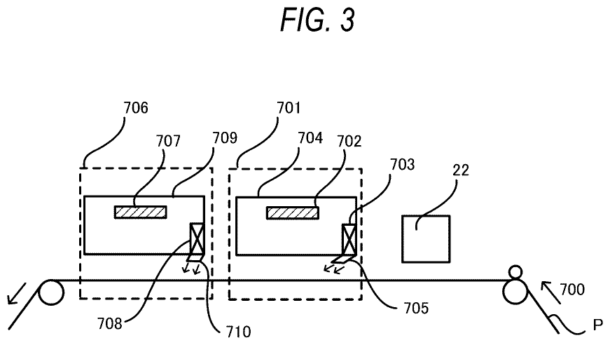

FIG. 3 is a schematic view showing an embodiment of an ink jet recording apparatus of the present invention. As shown in FIG. 3, the recording medium P is conveyed in the direction indicated by an arrow 700 by a paper feed roller (not shown). Above the recording medium P, a gas blowing device 701 for blowing gas to the recording medium is provided.

This gas blowing device 701 is a drying mechanism for reducing liquid components (such as water) contained in the reaction liquid and ink applied on the recording medium, and includes a heating element 702 for heating the gas (gas flow) to be blown, and a gas blowing part for blowing the heated gas to the recording medium P. The heating element 702 may be any device capable of controlling the temperature of the gas, and is preferably a device having high heat transfer efficiency to the air.

The gas blowing part includes a gas blowing fan 703, a gas blowing duct 704 and a gas blowing discharge part 705. From the viewpoint of power consumption, the gas blowing fan 703 may be configured to circulate a gas flow in the gas blowing device 701, or may be configured to take in outside air. A temperature sensor (not shown) is provided in the gas blowing duct 704, and the temperature of the heating element 702 can be detected and controlled. It is preferable to blow gas to the recording medium P from upstream in the conveying direction of the recording medium P. It is more preferable to provide the gas blowing device 701 on the upstream side relative to the recording head 22 in the conveying direction of the recording medium P and blow gas to the recording medium P from upstream in the conveying direction of the recording medium P. In this case, it is particularly preferable to blow gas in the horizontal direction from upstream in the conveying direction of the recording medium P toward the point right under the recording head 22. By adopting this manner, the ink and the reaction liquid are dried immediately after ejected from the recording head 22 and can be dried quickly. By blowing gas toward the surface of the recording medium P, a large amount of steam may be generated depending on the amount of ink and reaction liquid on the recording medium P. When the inside of the drying device 701 is filled with steam, the drying efficiency may decrease. For this reason, it may be configured to collect the generated steam and discharge it to the outside of the drying device 701.

The gas blowing device 701 may be any conventionally known device as long as it can dry liquid components contained in the reaction liquid and ink applied to the recording medium P to some extent, and thicken the reaction liquid, ink and their reaction products. Among them, it is preferable to use a mechanism incorporating a gas blowing fan 703 in order to send (blow) a gas flow to the surface of the recording medium P.

In the drying step, the ink and the reaction liquid are not sufficiently thickened. For this reason, in order to prevent the gas blowing from the ink ejection surface side of the recording medium P from affecting the shape of the surface of the ink and the reaction liquid, the gas is blown in a direction substantially horizontal to the ink ejection surface of the recording head 22. The gas blowing discharge part 705 may be arranged in plural along the conveying direction of the recording medium P.

The temperature of the gas blowing step can be set so that the recording medium P has a desired temperature in consideration of the conveying speed of the recording medium P and the environmental temperature. Specifically, it is preferable to blow a gas flow at 15° C. or more to 60° C. or less to the recording medium. It is more preferable to blow a gas flow at 25° C. or more to 60° C. or less to the recording medium. On the other hand, the temperature of the recording medium in the drying step is preferably less than 50° C. It is preferable to blow a gas flow at 1.0 m/s or more to 10.0 m/s or less to the recording medium P. The temperature of the gas flow to be blown can be measured using, for example, a K-type thermocouple thermometer. Specific examples of the measuring instrument include trade name “AD-5605H” (manufactured by A & D Company, Limited).

### [Heating Step]

The recording method of the present invention preferably further includes a heating step of heating and drying the recording medium at a temperature higher than that of the gas blowing step after the gas blowing step. In the heating step, the ink and its aggregates, which have been thickened to some extent in the gas blowing step, are rapidly heated and fixed on the recording medium to such an extent that they do not flow. In FIG. 3, the heating device 706 is a mechanism having the same configuration as the gas blowing device 701, and includes a heating element 707, a gas blowing fan 708, a gas blowing duct 709 and a gas blowing discharge part 710. The heating device 706 may be any device capable of further removing the liquid components that have been dried and removed to some extent by the gas blowing device 701. Among them, it is preferable from the viewpoint of energy efficiency to use a mechanism incorporating a fan for blowing a high-temperature gas (hot gas) to the recording medium P.

The heating temperature in the heating device 706 is preferably set to a temperature that does not cause over-drying from the viewpoint of rapidly evaporating liquid components and suppressing deformation of the recording medium P. Among them, it is preferable to heat to a temperature higher than the minimum film-forming temperature of the resin particle contained in the ink. When an ink containing wax particles is used, it is preferable to heat to a temperature lower than the minimum film-forming temperature of the wax particles. The minimum film-forming temperature is the minimum temperature required for the resin particle or wax particles to form a film. Specifically, a dispersion of resin particle or wax particles is applied onto a heat conductive plate with a temperature gradient, and dried to form a film of the resin particle or wax particles. The temperature at the position where the temperature of the heat conductive plate is the lowest in the non-whitened area of the formed film is defined as the minimum film-forming temperature.

The means for heating the recording medium is not particularly limited, and examples thereof include heating means such as known heating means such as a heater, gas blowing means using a gas blowing such as a dryer, and means combining these. That is, the ink jet recording apparatus preferably includes a mechanism (heating means) for heating the recording medium to which the ink and the reaction liquid have been applied. Examples of the heating means include the above-mentioned heating means, gas blowing means and means combining these. Examples of the heat treatment method include a method of applying heat from the side opposite to the recording surface (ink application surface) of the recording medium (back surface) with a heater or the like, a method of applying warm gas or hot gas to the recording surface of the recording medium and a method of heating from the recording surface or the back surface using an infrared heater.

The heating temperature of the recording medium to which the ink and the reaction liquid have been applied is preferably 50° C. or more to 90° C. or less, because the abrasion resistance of the image can be enhanced. The heating temperature of the recording medium to which the ink and the reaction liquid have been applied may be read by a sensor incorporated at a position corresponding to the heating means of the recording apparatus, or may be determined from the relationship between the amount of heat determined according to the type of ink and recording medium and the temperature of the recording medium.

In the recording apparatus shown in FIGS. 1 and 2, a heater 25 as a heating device supported by a frame (not shown) is arranged at a position downstream in the sub-scanning direction A from the position where the recording head 22 reciprocates in the main scanning direction B. The recording medium 1 to which the ink has been applied can be heated by the heater 25. Specific examples of the heater 25 include a sheathed heater and a halogen heater. The heater 25 is covered with a heater cover 26. The heater cover 26 is a member for efficiently irradiating the recording medium 1 with the heat generated from the heater 25. Furthermore, the heater cover 26 is also a member that protects the heater 25. The recording medium 1 to which the ink ejected from the recording head 22 has been applied is wound up by a winding spool 27 to form a roll-shaped winding medium 24.

### (Recording Medium)

In the recording method and recording apparatus of the present invention, a non-absorbent recording medium (low- to non-absorbent recording medium) is used as the recording medium. The non-absorbent recording medium is a medium in which, according to the Bristow method described in JAPAN TAPPI Paper Pulp Test Method No. 51 “PAPER AND BOARD—LIQUID ABSORBABILITY TEST METHOD—BRISTOW'S METHOD,” the water absorption amount from the start of contact to 30 msec^{1/2} is 0 mL/m² or more to 10 mL/m² or less. In the present invention, a recording medium that satisfies the above conditions for the amount of water absorption is defined as a “low- to non-absorbent recording medium.” A recording medium for ink jet recording (glossy paper, matte paper, etc.) having an ink receiving layer formed of inorganic particles, and plain paper having no coat layer are “absorbent recording media” having a water absorption amount of more than 10 mL/m².

Examples of the non-absorbent recording medium include a plastic film; a recording medium in which a plastic film is adhered to a recording surface of a base material; and a recording medium in which an organic resin coat layer is provided on a recording surface of a base material containing cellulose pulp. Among these, a plastic film is preferable, and a recording medium in which an organic resin coat layer as an organic resin layer is provided on the recording surface of a base material containing cellulose pulp is also preferable.

When the ink used in the recording method and recording apparatus of the present invention is applied to a non-absorbent recording medium, components such as water and a water-soluble organic solvent are volatilized and the resin particle is concentrated. Thereby, the fusion between the concentrated resin particle is promoted, and the abrasion resistance of the recorded image is improved. On the other hand, when ink is applied to a recording medium having high absorbency of liquid components, the fusion between the resin particle is not easily promoted, so that the effect of improving the abrasion resistance of the image becomes insufficient. The recording medium in the present specification means a recording medium on which an image as a recorded matter is recorded, not a transfer body.

### (Ink)

The ink is an aqueous ink for ink jet containing a pigment, a resin particle and a water-soluble organic solvent. Hereinafter, each component constituting the ink will be described in detail.

### [Coloring Material]

The ink contains a pigment as a coloring material. The content (% by mass) of the pigment in the ink is preferably 0.1% by mass or more to 15.0% by mass or less, and more preferably 1.0% by mass or more to 10.0% by mass or less, based on the total mass of the ink.

Specific examples of the pigment include inorganic pigment such as carbon black and titanium oxide; and organic pigment such as azo, phthalocyanine, quinacridone, isoindolinone, imidazolone, diketopyrrolopyrrole, dioxazine and perinone.

As a dispersion method of the pigment, a resin-dispersed pigment using a resin as a dispersant, a self-dispersing pigment in which a hydrophilic group is bonded to the particle surface of the pigment or the like can be used. Further, a resin-bonded pigment in which an organic group containing a resin is chemically bonded to the particle surface of the pigment, a microcapsule pigment in which the surface of pigment particles is coated with a resin or the like or the like can be used. Among them, it is preferable to use a resin-dispersed pigment in which a resin as a dispersant is physically adsorbed on the particle surface of the pigment, instead of a resin-bonded pigment or a microcapsule pigment. That is, the pigment is preferably a pigment dispersed by the action of a resin dispersant.

As the resin dispersant for dispersing the pigment in the aqueous medium, one capable of dispersing the pigment in the aqueous medium by the action of an anionic group is preferably used. As the resin dispersant, a resin described later, particularly a water-soluble resin, can be used. The content (% by mass) of the pigment in the ink is preferably 0.3 times or more to 10.0 times or less in terms of the mass ratio with respect to the content of the resin dispersant.

As the self-dispersing pigment, one in which an anionic group such as a carboxylic acid group, a sulfonic acid group or a phosphonic acid group is bonded to the particle surface of the pigment directly or via another atomic group (—R—) can be used. The anionic group may be either an acid type or a salt type, and in the case of a salt type, it may be in a state where a part of it is dissociated or all of it is dissociated. When the anionic group is a salt type, examples of the counter ion serving as a cation include an alkali metal cation, ammonium and organic ammonium. Specific examples of the other atomic group (—R—) include a linear or branched alkylene group having 1 to 12 carbon atoms; an arylene group such as a phenylene group and a naphthylene group; a carbonyl group; an imino group; an amide group; a sulfonyl group; an ester group; and an ether group. A group obtained by combining these groups may also be used.

An inorganic oxide such as titanium oxide reacts with water molecules in the ink to form hydroxyl groups on the surface (hereinafter, also referred to as “surface hydroxyl groups”). For this reason, in the case of an aqueous ink for ink jet, titanium oxide surface-treated with an inorganic oxide such as alumina or silica is generally used in order to further improve the storage stability of the ink while utilizing the surface hydroxyl groups. The surface hydroxyl group of particulate titanium oxide (titanium oxide particles) has properties inherent to the inorganic oxide used for the surface treatment, and the isoelectric point, which is an index of the strength as an acid, differs depending on the type of inorganic oxide. For this reason, the surface of the titanium oxide particles shows the properties of the inorganic oxide used for the surface treatment (surface treatment agent), and the surface charge of the titanium oxide particles strongly depends on the pH of the aqueous medium, the type of the surface treatment agent and the amount of the surface treatment agent used.

Titanium oxide is a white pigment having three crystal forms of rutile type, anatase type and brookite type. Among them, rutile-type titanium oxide is preferable. Examples of the industrial manufacturing method of titanium oxide include a sulfuric acid method and a chlorine method. Titanium oxide may be obtained by any manufacturing method.

Titanium oxide may be surface-coated (surface-treated) with an inorganic oxide or an organic substance. Among them, it is preferable to use one that is surface-treated with alumina and silica. By using surface-treated titanium oxide, suppression of photocatalytic activity and improvement of dispersibility are expected. “Alumina” in the present specification is a general term for aluminum oxides such as aluminum oxide. “Silica” in the present specification is a general term for silicon dioxide and substances composed of silicon dioxide. Most of the alumina and silica that coat the titanium oxide are present in the form of silicon dioxide and aluminum oxide. Examples of a method for measuring the proportion of alumina and silica in the titanium oxide particles, that is, the coating amount of alumina and silica, include a quantitative analysis method of aluminum and silicon elements by inductively coupled plasma (ICP) emission spectrometry. In this case, it can be calculated by assuming that all atoms coating the surface are oxides and converting the obtained values of aluminum and silicon into oxides (alumina and silica).

Examples of the surface treatment method of titanium oxide include a wet treatment method and a dry treatment method. For example, after dispersing titanium oxide in a liquid medium, it can be surface-treated by reacting with a surface treatment agent such as sodium aluminate or sodium silicate. By appropriately changing the ratio of these surface treatment agents, it is also possible to adjust to desired characteristics. For the surface treatment, as long as the effects of the present invention are not impaired, inorganic oxides such as zinc oxide and zirconia; and organic substances such as polyol can be used in addition to alumina and silica.

### [Resin Particle]

The ink contains resin particle. The content (% by mass) of the resin particle in the ink is preferably 0.1% by mass or more to 15.0% by mass or less, and more preferably 1.0% by mass or more to 10.0% by mass or less, based on the total mass of the ink. The content (% by mass) of the resin particle in the ink is preferably 1.5 times or more, more preferably 1.7 times or more, in terms of the mass ratio with respect to the content (% by mass) of the pigment. The above mass ratio is preferably 10.0 times or less. The resin particle is present in the ink in a dispersed state, that is, in the form of a resin emulsion.

The “resin particle” in the present specification means a resin that is present in a state of not being dissolved in an aqueous medium in the ink, and more specifically, means a resin that can be present in the aqueous medium in a state of forming particles whose particle diameter can be measured by a dynamic light scattering method. On the other hand, the “water-soluble resin” means a resin that is present in a state of being dissolved in an aqueous medium in the ink. The “resin particle” can also be referred to as “water-dispersible resin (water-insoluble resin).”

Whether or not a certain resin corresponds to “resin particle” can be determined according to the method shown below. First, a liquid containing a resin to be judged is prepared, and the liquid is diluted with pure water so that the content of the resin is about 1.0% to prepare a sample. Then, when the particle diameter of the resin in the sample is measured by a dynamic light scattering method, if particles having a particle diameter are measured, the resin is determined to be “resin particle” (that is, “water-dispersible resin”). On the other hand, if particles having a particle diameter are not measured, the resin is determined not to be “resin particle” (that is, “water-soluble resin”). The measurement conditions at this time can be, for example, as follows.

### [Measurement Conditions]

SetZero: 30 s
Number of measurements: 3 times
Measurement time: 120 seconds
Shape: True sphere
Refractive index: 1.6
Density: 1.0

As the particle size distribution measuring device, a particle size analyzer using a dynamic light scattering method (for example, trade name “NANOTRAC WAVE II Q,” manufactured by MicrotracBEL Corp.) can be used.

Of course, the particle size distribution measuring device to be used and the measurement conditions are not limited to the above. The average particle diameter (cumulative 50% particle diameter based on volume) of pigment and wax particles can be measured under the above apparatus and conditions. The average particle diameter of the resin particle is the diameter of particles that are integrated from the small particle diameter side to 50% based on the total volume of the measured particles in the particle diameter integration curve.

The average particle diameter (cumulative 50% particle diameter based on volume (D50)) of the resin particle measured by a dynamic light scattering method is preferably 60 nm or more to 180 nm or less. By using the ink containing the resin particle having an average particle diameter within the above range, the abrasion resistance of the recorded image can be further improved.

The acid value of the resin constituting the resin particle is preferably 5 mg KOH/g or more to 100 mg KOH/g or less. The weight average molecular weight of the resin constituting the resin particle is preferably 1,000 or more to 2,000,000 or less. The resin particle does not need to include a coloring material.

The glass transition temperature of the resin particle is preferably 40° C. or more to 120° C. or less, and more preferably 50° C. or more to 100° C. or less. The glass transition temperature of the resin particle can be measured using a differential scanning calorimeter (DSC).

As the constituent unit of the resin constituting the resin particle, the same units as those constituting the water-soluble resin described later can be appropriately selected and used. Specific examples thereof include acrylic resin, urethane resin, polyester resin and various copolymers.

Examples of the copolymer include styrene-acrylic resin, styrene-butadiene resin, polyether-polyurethane resin and polyester-polyurethane resin.

The reactivity of the resin particle can be controlled, for example, by adjusting the density of anionic groups on the surface of the resin particle, the acid value of the resin particle or the like. By increasing the density of the carboxylic acid groups of the resin particle or increasing the acid value of the resin particle, the viscosity of the mixture obtained by mixing the ink and the reaction liquid can be increased.

### [Water-Soluble Resin]

The ink may contain a water-soluble resin (hereinafter, also simply referred to as “resin”).

By using the ink containing the water-soluble resin, the abrasion resistance of the recorded image can be further improved. The water-soluble resin can be added to the ink (i) to stabilize the dispersed state of the pigment, that is, as a resin dispersant or an auxiliary thereof. Further, (ii) it can be added to the ink to improve various properties of the recorded image. Examples of the form of the water-soluble resin include a block copolymer, a random copolymer, a graft copolymer and combinations thereof.

The content (% by mass) of the resin in the ink is preferably 0.1% by mass or more to 20.0% by mass or less, and more preferably 0.5% by mass or more to 15.0% by mass or less, based on the total mass of the ink.

### [Composition of Resin]

Examples of the resin include an acrylic resin, a urethane resin and an olefin resin. Among them, an acrylic resin and a urethane resin are preferable, and an acrylic resin composed of a unit derived from (meth)acrylic acid or (meth)acrylate is more preferable.

As the acrylic resin, one having a hydrophilic unit and a hydrophobic unit as constituent units is preferable. Among them, a resin having a hydrophilic unit derived from (meth)acrylic acid and a hydrophobic unit derived from at least one selected from the group consisting of a monomer having an aromatic ring and a (meth)acrylic acid ester monomer is preferable. In particular, a resin having a hydrophilic unit derived from (meth)acrylic acid and a hydrophobic unit derived from at least one monomer selected from the group consisting of styrene and α-methylstyrene is preferable. These resins are suitably used as a resin dispersant for dispersing a pigment because interaction with the pigment is likely to occur.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include acidic monomers having a carboxylic acid group such as (meth)acrylic acid, itaconic acid, maleic acid and fumaric acid, and anionic monomers such as anhydrides and salts of these acidic monomers. Examples of the cation constituting the salt of the acidic monomer include ions such as lithium, sodium, potassium, ammonium and organic ammonium. The hydrophobic unit is a unit having no hydrophilic group such as an anionic group. The hydrophobic unit can be formed, for example, by polymerizing a hydrophobic monomer having no hydrophilic group such as an anionic group. Specific examples of the hydrophobic monomer include monomers having an aromatic ring such as styrene, α-methylstyrene and benzyl (meth)acrylate; and (meth)acrylic acid ester monomers such as methyl (meth)acrylate, butyl (meth)acrylate and 2-ethylhexyl (meth)acrylate.

The urethane resin can be obtained, for example, by reacting a polyisocyanate with a polyol. Further, it may be one further reacted with a chain extender. Examples of the olefin resin include polyethylene and polypropylene.

### [Properties of Resin]

The acid value of the water-soluble resin is preferably 100 mg KOH/g or more to 250 mg KOH/g or less. The weight average molecular weight of the water-soluble resin is preferably 3,000 or more to 15,000 or less.

### [Wax Particle]

The ink may contain particles formed of wax (wax particles).

By using the ink containing the wax particles, an image with further improved abrasion resistance can be recorded. The wax may be a composition containing components other than wax, or may be wax itself. The wax particles may be dispersed by a dispersant such as a surfactant or a water-soluble resin. One type of wax may be used alone, or two or more types may be used in combination. The content (% by mass) of the wax particles in the ink is preferably 1.0% by mass or more to 5.0% by mass or less, and more preferably 1.5% by mass or more to 3.0% by mass or less, based on the total mass of the ink.

Wax, in a narrow sense, is an ester of a higher monohydric or dihydric alcohol insoluble in water and a fatty acid, and includes animal wax and vegetable wax, but does not include fats and oils. In a broad sense, it includes high-melting point fats, mineral wax, petroleum wax and blends and modified products of various waxes. In the recording method of the present invention, any wax in a broad sense can be used without particular limitation. Wax in a broad sense can be classified into natural wax, synthetic wax, blends of these (blended wax) and modified products of these (modified wax).

Examples of the natural wax include animal wax, vegetable wax, mineral wax and petroleum wax. Examples of the animal wax include beeswax, spermaceti wax and wool wax (lanolin). Examples of the vegetable wax include palm wax, carnauba wax, candelilla wax, rice wax, Japan wax, ouricury wax and sugarcane wax. Examples of the mineral wax include montan wax, ozokerite, ceresin and lignite wax. Examples of the petroleum wax include paraffin, microcrystalline and petrolatum waxes.

Examples of the synthetic wax include hydrocarbon wax such as Fischer-Tropsch wax and polyolefin wax (e.g., polyethylene wax, polypropylene wax). The blended wax is a mixture of the above various waxes. The modified wax is obtained by subjecting the above various waxes to a modification treatment such as oxidation, hydrogenation, alcohol modification, acrylic modification or urethane modification. Examples of the modified wax include a paraffin wax derivative, a montan wax derivative and a microcrystalline wax derivative. Examples of the hydrogenated wax include castor wax and opal wax.

The wax is preferably solid at room temperature (25° C.). The melting point (° C.) of the wax is preferably 40° C. or more to 120° C. or less, and more preferably 50° C. or more to 100° C. or less. The melting point of the wax can be measured according to the test method described in 5.3.1 (melting point test method) of JIS K 2235:1991 (petroleum wax). In the case of microcrystalline wax, petrolatum and a mixture of a plurality of waxes, the test method described in 5.3.2 can be used for more accurate measurement. The melting point of the wax is easily affected by properties such as molecular weight (the larger the molecular weight, the higher the melting point), molecular structure (linear structure has a high melting point, branching lowers the melting point), crystallinity (the higher the crystallinity, the higher the melting point) and density (the higher the density, the higher the melting point).

For this reason, by controlling these properties, a wax having a desired melting point can be obtained. The melting point of the wax in the ink can be measured, for example, by washing and drying the wax separated by ultracentrifugation of the ink, and then measuring according to the above test method.

### [Aqueous Medium]

The ink is an aqueous ink containing at least water as an aqueous medium. As the water, deionized water or ion-exchanged water is preferably used. The content (% by mass) of water in the ink is preferably 50.0% by mass or more to 95.0% by mass or less based on the total mass of the ink.

The ink contains a water-soluble organic solvent. After the ink is applied to the non-absorbent recording medium, water is volatilized and reduced in the gas blowing step, whereby the water-soluble organic solvent and the resin particle are concentrated. Thereby, the fusion between the concentrated resin particle is promoted, and the abrasion resistance of the recorded image is improved. As the water-soluble organic solvent, any of those usable in ink jet inks such as alcohols, (poly)alkylene glycols, glycol ethers, nitrogen-containing solvents and sulfur-containing solvents can be used. One type of water-soluble organic solvent may be used alone, or two or more types may be used in combination. The content (% by mass) of the water-soluble organic solvent in the ink is preferably 3.0% by mass or more to 50.0% by mass or less based on the total mass of the ink.

The vapor pressure of the water-soluble organic solvent at 25° C. and 1 atmosphere is preferably 1.0 kPa or less. If the vapor pressure is too high, the water-soluble organic solvent may evaporate before sufficiently contacting the resin particle in the ink, and the effect of improving the abrasion resistance of the image may not be sufficiently obtained.

### [Other Components]

The ink may contain various other components as necessary. Examples of the other components include various additives such as an antifoaming agent, a surfactant, a pH adjuster, a viscosity adjuster, a rust inhibitor, a preservative, an antifungal agent, an antioxidant and a reduction inhibitor. However, the ink preferably does not contain the reactant contained in the reaction liquid.

### [Physical Properties of Ink]

The ink is an aqueous ink applied to an ink jet method. Therefore, from the viewpoint of reliability, it is preferable to appropriately control its physical property values. Specifically, the surface tension of the ink at 25° C. is preferably 20 mN/m or more to 60 mN/m or less. The viscosity of the ink at 25° C. is preferably 1.0 mPa's or more to 10.0 mPa's or less. The pH of the ink at 25° C. is preferably 7.0 or more to 9.5 or less, and more preferably 8.0 or more to 9.5 or less.

### (Reaction Liquid)

The reaction liquid used in the recording method of the present invention is a liquid containing a reactant that reacts with the ink, and is an aqueous reaction liquid for ink jet used together with the ink. The recording method of the present invention includes, for example, a step of applying a reaction liquid to a recording medium. Among them, it is preferable to apply the reaction liquid before applying the ink to the recording medium, or to apply the ink and the reaction liquid in parallel. Hereinafter, each component used in the reaction liquid will be described in detail.

### [Reactant]

The reaction liquid contains a reactant that reacts with the ink when it comes into contact with the ink, and aggregates components in the ink (components having an anionic group such as a resin, a surfactant and a self-dispersing pigment). Examples of the reactant include an organic acid, a polyvalent metal salt and a cationic resin.

### [Organic Acid]

The reaction liquid containing an organic acid has a buffering capacity in an acidic area (pH less than 7.0, preferably pH 2.0 to 5.0), thereby efficiently converting the anionic groups of the components present in the ink into an acid type and aggregating them. Examples of the organic acid include monocarboxylic acids such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid as well as salts thereof; dicarboxylic acids such as oxalic acid, malonic acid, succinic acid, glutaric acid, adipic acid, maleic acid, fumaric acid, itaconic acid, sebacic acid, phthalic acid, malic acid and tartaric acid as well as salts and hydrogen salts thereof; tricarboxylic acids such as citric acid and trimellitic acid as well as salts and hydrogen salts thereof; and tetracarboxylic acids such as pyromellitic acid as well as salts and hydrogen salts thereof. The content (% by mass) of the organic acid in the reaction liquid is preferably 1.0% by mass or more to 50.0% by mass or less based on the total mass of the reaction liquid.

### [Polyvalent Metal Salt]

The polyvalent metal salt is a compound composed of a divalent or higher valent metal ion (polyvalent metal ion) and an anion. The polyvalent metal salt dissociates in the reaction liquid to become a polyvalent metal ion, and aggregates a pigment or the like dispersed by the action of an anionic group in the ink. Examples of the polyvalent metal ion include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. Examples of the anion constituting the polyvalent metal salt include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻.

Specific examples of the polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, aluminum sulfate, calcium methanesulfonate, calcium lactate, magnesium lactate, calcium propionate, calcium pantothenate and calcium gluconate. These polyvalent metal salts may have water of hydration. The content (% by mass) of the polyvalent metal salt in the reaction liquid is preferably 1.0% by mass or more to 20.0% by mass or less based on the total mass of the reaction liquid.

### [Cationic Resin]

The cationic resin has a cationic site in the structure of the resin, and aggregates a pigment or the like dispersed by the action of an anionic group in the ink. Examples of the cationic resin include a resin having a structure of a primary to tertiary amine and a resin having a structure of a quaternary ammonium salt. Specific examples thereof include resins having a structure of vinylamine, allylamine, vinylimidazole, vinylpyridine, dimethylaminoethyl methacrylate, ethyleneimine, guanidine, diallyldimethylammonium chloride and an alkylamine-epichlorohydrin condensate. In order to enhance the solubility in the reaction liquid, an acidic compound and a cationic resin can be used in combination, or a quaternization treatment of the cationic resin can be performed. The content (% by mass) of the cationic resin in the reaction liquid is preferably 0.1% by mass or more to 10.0% by mass or less based on the total mass of the reaction liquid.

### [Aqueous Medium]

The reaction liquid is an aqueous reaction liquid containing at least water as an aqueous medium. As the aqueous medium used for the reaction liquid, the same ones as the above-mentioned aqueous medium that can be contained in the ink can be mentioned.

The Hansen SP value (HSP1) of the resin particle in the ink and the Hansen SP value (HSP2) of the water-soluble organic solvent in the reaction liquid preferably satisfy the relationship of the following formula (1). When the resin particle and the water-soluble organic solvent satisfying the relationship of the following formula (1) are used, dissolution and swelling of the resin particle can be effectively promoted to enhance the film-forming property, and the abrasion resistance of the recorded image can be further improved.

$$\vert HSP 1 - HSP 2 \vert \leq 5. \qquad ( 1 )$$

The Hansen SP value (HSP1) of the resin particle in the present specification is a value measured by a dynamic light scattering method. The Hansen SP value (HSP2) of the water-soluble organic solvent is a value of Hansen Solubility Parameters in Practice 4th Edition 4.1.07 (HSPiP), which is computer software.

### [Other Components]

The reaction liquid may contain various other components as necessary. Examples of the other components include the same ones as the above-mentioned other components that can be contained in the ink.

### [Physical Properties of Reaction Liquid]

The reaction liquid is an aqueous reaction liquid applied to an ink jet method. Therefore, from the viewpoint of reliability, it is preferable to appropriately control its physical property values. Specifically, the surface tension of the reaction liquid at 25° C. is preferably 20 mN/m or more to 60 mN/m or less. The viscosity of the reaction liquid at 25° C. is preferably 1.0 mPa's or more to 10.0 mPa's or less. The pH of the reaction liquid at 25° C. is preferably 5.0 or more to 9.5 or less, and more preferably 6.0 or more to 9.0 or less.

### [Reaction Strength of Reaction Liquid]

The reaction liquid includes a first reaction liquid and a second reaction liquid having a reaction strength with the ink lower than that of the first reaction liquid. The image recorded by the recording method of the present invention includes a low gloss area formed by applying the first reaction liquid and the ink, and a high gloss area formed by applying the second reaction liquid and the ink. The viscosity (Pa's) of a first mixture obtained by mixing 100 parts by mass of the ink and 7 parts by mass of the first reaction liquid is preferably 2.0 times or more in terms of the ratio with respect to the viscosity (Pa·s) of a second mixture obtained by mixing 100 parts by mass of the ink and 7 parts by mass of the second reaction liquid. The above ratio is more preferably 2.0 times or more to 5.0 times or less. By using the first reaction liquid and the second reaction liquid having the above ratio of 2.0 times or more, an image with more partially controlled glossiness can be recorded.

In Examples described later, the viscosity of a mixture (first mixture, second mixture) obtained by mixing the ink and the reaction liquid was measured by the following procedure. First, a mixture obtained by mixing the ink and the reaction liquid at a predetermined mass ratio (i.e. 7 mass part of an aqueous reaction liquid relative to 100 mass part of an aqueous ink) is stirred for 10 seconds at memory 10 using a vortex mixer (trade name “TUBE MIXER™-2N”, manufactured by AS ONE Corporation). After stirring, the viscosity of the mixture can be measured using an E-type viscometer (trade name “RE-80L”, manufactured by Toki Sangyo Co., Ltd.).

The viscosity of the mixture can be controlled, for example, by adjusting the content of the reactant in the reaction liquid, the content of the cationic resin, the molecular weight of the cationic resin, the cationicity of the cationic resin, the valence of the organic acid and the like. The viscosity of the mixture can also be controlled by adjusting the composition of the ink to be used in combination. For example, when the ink contains a self-dispersing pigment, the viscosity of the mixture can be controlled by adjusting the density of carboxylic acid groups bonded directly or via another atomic group to the particle surface of the pigment. When the ink contains a resin-dispersed pigment, the viscosity of the mixture can be controlled by adjusting the acid value of the resin dispersant to be used. Furthermore, the viscosity of the mixture can also be controlled by adjusting the acid value of the resin constituting the resin particle in the ink, the content of the resin particle, the acid value of the water-soluble resin, the content of the water-soluble resin and the like. For example, the viscosity of the mixture can be increased by increasing the density of the carboxylic acid groups of the self-dispersing pigment, increasing the acid value of the resin dispersant of the resin-dispersed pigment, increasing the acid value of the resin constituting the resin particle or increasing the acid value of the water-soluble resin.

According to one aspect of the present invention, it is possible to provide an ink jet recording method capable of recording an image on a low- to non-absorbent recording medium, wherein the image includes a low gloss area having excellent abrasion resistance and a high gloss area having suppressed bleeding, and the image has a glossiness that is partially controlled. According to another aspect of the present invention, it is possible to provide an ink jet recording apparatus used in the ink jet recording method, and a set of an aqueous ink and an aqueous reaction liquid.

### EXAMPLES

Hereinafter, the present invention will be described in more detail with reference to Examples and Comparative Examples, but the present invention is not limited to the following Examples as long as the gist thereof is not exceeded. The terms “parts” and “%” regarding the amount of components are based on mass unless otherwise specified.

### <Preparation of Reaction Liquid>

The components (unit: %) shown in Tables 1 and 2 were mixed and sufficiently stirred, and then pressure-filtered with a cellulose acetate filter (manufactured by Advantec Co., Ltd.) having a pore size of 3.0 μm to prepare the first reaction liquids 1-6 shown in Table 1 and the second reaction liquids 1-4 shown in Table 2, respectively. When magnesium sulfate was used as a reactant, the amount of magnesium sulfate heptahydrate is shown in Tables 1 and 2. The details of each component in Tables 1 and 2 are shown below.
Polyquat 40U05NV: Aqueous solution of cationic resin, concentration 40.0%, manufactured by Katpol GmbH
Acetylenol E100: Acetylene glycol-based surfactant, manufactured by Kawaken Fine Chemicals Co., Ltd.
PROXEL GXL(S): Preservative, manufactured by Arch Chemicals, Inc.

TABLE 1
Composition of First Reaction Liquid

| | 1st Reaction Liquid | | | | | |
|---|---|---|---|---|---|---|
| | 1 | 2 | 3 | 4 | 5 | 6 |
| Magnesium Sulfate | 12.0 | | | 10.0 | 8.0 | 4.0 |
| Heptahydrate | | | | | | |
| Succinic Acid | | 6.0 | | | | |
| Polyquat 40U05NV | | | 15.0 | | | |
| 1,2-Butanediol | 20.0 | 20.0 | 20.0 | 20.0 | 20.0 | 20.0 |
| Acetylenol E100 | 0.5 | 0.5 | 0.5 | 0.5 | 0.5 | 0.5 |
| PROXEL GXL(S) | 0.2 | 0.2 | 0.2 | 0.2 | 0.2 | 0.2 |
| Ion-exchanged Water | 67.3 | 73.3 | 64.3 | 69.3 | 71.3 | 75.3 |

TABLE 2
Composition of Second Reaction Liquid

2nd Reaction Liquid

| | 1 | 2 | 3 | 4 |
|---|---|---|---|---|
| Magnesium Sulfate | 4.0 | | | 12.0 |
| Heptahydrate | | | | |
| Succinic Acid | | 2.0 | | |
| Polyquat 40U05NV | | | 5.0 | |
| 1,2-Butanediol | 20.0 | 20.0 | 20.0 | 20.0 |
| Acetylenol E100 | 0.5 | 0.5 | 0.5 | 0.5 |
| PROXEL GXL(S) | 0.2 | 0.2 | 0.2 | 0.2 |
| Ion-exchanged Water | 75.3 | 77.3 | 74.3 | 67.3 |

### <Preparation of Pigment Dispersion>

### (Pigment Dispersion 1)

A styrene-ethyl acrylate-acrylic acid copolymer (resin dispersant) having an acid value of 150 mg KOH/g and a weight average molecular weight of 8,000 was prepared. 20.0 parts of the resin dispersant was neutralized with potassium hydroxide in an equimolar amount to the acid value, and an appropriate amount of pure water was added to prepare an aqueous solution of the resin dispersant having a resin (solid content) content of 20.0%, 10.0 parts of C.I. Pigment Blue 15:3, 15.0 parts of the aqueous solution of the resin dispersant and 75.0 parts of pure water were mixed to obtain a mixture. The obtained mixture and 200 parts of zirconia beads having a diameter of 0.3 mm were placed in a batch-type vertical sand mill (manufactured by AIMEX Co., Ltd.), and dispersed for 5 hours while cooling with water. After removing coarse particles by centrifugation, the mixture was pressure-filtered with a cellulose acetate filter (manufactured by Advantec Co., Ltd.) having a pore size of 3.0 μm. As a result, pigment dispersion 1 having a pigment content of 10.0% and a resin dispersant content of 3.0% was obtained.

### (Pigment Dispersion 2)

Pigment dispersion 2 having a pigment content of 10.0% and a resin dispersant content of 3.0% was obtained in the same manner as in the case of pigment dispersion 1 except that C.I. Pigment Red 122 was used instead of C.I. Pigment Blue 15:3.

### (Pigment Dispersion 3)

Pigment dispersion 3 having a pigment content of 10.0% and a resin dispersant content of 3.0% was obtained in the same manner as in the case of pigment dispersion 1 except that C.I. Pigment Yellow 74 was used instead of C.I. Pigment Blue 15:3.

### (Pigment Dispersion 4)

Pigment dispersion 4 having a pigment content of 10.0% and a resin dispersant content of 3.0% was obtained in the same manner as in the case of pigment dispersion 1 except that carbon black was used instead of C.I. Pigment Blue 15:3.

### (Pigment Dispersion 5)

40.0 parts of rutile-type titanium oxide, 1.2 parts of 3-(methoxy (polyoxyethylene)9-12) propyltrimethoxysilane and ion-exchanged water in a total amount of 100.0 parts were mixed, and pre-dispersed using a homogenizer. As the rutile-type titanium oxide, trade name “TITANIX JR-800” (manufactured by Tayca Corporation, surface treatment: alumina, silica) was used. Thereafter, dispersion treatment was performed at 25° C. for 12 hours using 0.5 mm zirconia beads with a paint shaker. The zirconia beads were filtered off, and if necessary, an appropriate amount of ion-exchanged water was added to obtain pigment dispersion 5 having a pigment (titanium oxide) content of 40.0%.

### <Production of Resin Particle>

### (Resin Particle 1)

74.0 parts of ion-exchanged water and 0.2 parts of potassium persulfate were placed in a four-necked flask equipped with a stirrer, a reflux condenser and a nitrogen gas inlet tube, and mixed. Separately, 24.0 parts of ethyl methacrylate, 1.5 parts of methacrylic acid and 0.3 parts of a reactive surfactant were mixed to prepare an emulsion. As the reactive surfactant, trade name “ADEKA REASOAP ER20” (manufactured by ADEKA Corporation, nonionic surfactant, number of moles of ethylene oxide groups added: 20) was used.

Under a nitrogen atmosphere, the prepared emulsion was added dropwise into the above four-necked flask over 1 hour, and a polymerization reaction was performed at 80° C. with stirring for 2 hours. After cooling to 25° C., an aqueous solution containing ion-exchanged water and potassium hydroxide in an equimolar amount to the acid value of the resin particle was added to prepare an aqueous dispersion of resin particle 1 having a resin particle (solid content) content of 25.0%. The average particle diameter of resin particle 1 was 180 nm.

### (Resin Particle 2)

An aqueous dispersion of resin particle 2 having a resin particle (solid content) content of 25.0% was prepared in the same procedure as resin particle 1 except that the polymerization temperature was changed to 60° C. The average particle diameter of resin particle 2 was 200 nm.

### (Resin Particle 3)

An aqueous dispersion of resin particle 3 having a resin particle (solid content) content of 25.0% was prepared in the same procedure as resin particle 1 except that the polymerization temperature was changed to 95° C. The average particle diameter of resin particle 3 was 60 nm.

### <Preparation of Ink>

The components (unit: %) shown in Table 3 were mixed and sufficiently stirred, and then pressure-filtered with a cellulose acetate filter (manufactured by Advantec Co., Ltd.) having a pore size of 3.0 μm to prepare inks 1-9, respectively. The details of each component in Table 3 are shown below.
Acetylenol E100: Acetylene glycol-based surfactant, manufactured by Kawaken Fine Chemicals Co., Ltd.
PROXEL GXL(S): Preservative, manufactured by Arch Chemicals, Inc.

TABLE 3
Composition of Ink

| | Ink | | | | | | | | |
|---|---|---|---|---|---|---|---|---|---|
| | 1 | 2 | 3 | 4 | 5 | 6 | 7 | 8 | 9 |
| Pigment | 30.0 | | | | 30.0 | 30.0 | 30.0 | 30.0 | 30.0 |
| Dispersion 1 | | | | | | | | | |
| Pigment | | 30.0 | | | | | | | |
| Dispersion 2 | | | | | | | | | |
| Pigment | | | 30.0 | | | | | | |
| Dispersion 3 | | | | | | | | | |
| Pigment | | | | 7.5 | | | | | |
| Dispersion 4 | | | | | | | | | |
| Pigment | | | | | | | | | |
| Dispersion 5 | | | | | | | | | |
| Resin Particle | 40.0 | 40.0 | 40.0 | 40.0 | 40.0 | | | | 40.0 |
| Dispersion 1 | | | | | | | | | |
| Resin Particle | | | | | | 40.0 | | | |
| Dispersion 2 | | | | | | | | | |
| Resin Particle | | | | | | | 40.0 | | |
| Dispersion 3 | | | | | | | | | |
| 1,2-Butanediol | 20.0 | 20.0 | 20.0 | 20.0 | 20.0 | 20.0 | 20.0 | 20.0 | |
| Acetylenol E100 | 0.5 | 0.5 | 0.5 | 0.5 | 0.5 | 0.5 | 0.5 | 0.5 | 0.5 |
| PROXEL GXL(S) | 0.2 | 0.2 | 0.2 | 0.2 | 0.2 | 0.2 | 0.2 | 0.2 | 0.2 |
| Ion-exchanged | 9.3 | 9.3 | 9.3 | 31.8 | 9.3 | 9.3 | 9.3 | 49.3 | 29.3 |
| Water | | | | | | | | | |

### <Preparation of Recording Medium>

Recording media 1 and 2 shown below were prepared. The recording medium 1 is a recording medium having a water absorption of 0 mL/m² or more to 10 mL/m² or less from the start of contact to 30 msec^{1/2} in the Bristow method. On the other hand, the recording medium 2 is a recording medium having a water absorption of more than 10 mL/m² from the start of contact to 30 msec^{1/2} in the Bristow method.
Recording medium 1: Trade name “Scotchcal Graphic Film IJ1220N,” manufactured by 3M, material: Polyvinyl chloride
Recording medium 2: High-quality special paper, trade name “HR-101S,” manufactured by Canon Inc.

### <Evaluation>

### (Image Recording)

An ink jet recording apparatus (trade name “imagePROGRAF PRO-2000”, manufactured by Canon Inc.) equipped with a recording head that ejects ink by thermal energy was prepared. This ink jet recording apparatus is defined such that the recording duty of an image recorded under the condition of applying 1 ink droplet of 4.0 ng to a unit area of 1/1,200 inch× 1/1,200 inch is 100%. A gas blowing device that blows gas to reduce liquid components on the recording medium to which the reaction liquid and ink have been applied, and a heating device that subsequently heats and dries the recording medium were incorporated in the prepared ink jet recording apparatus. The first reaction liquid, the second reaction liquid and the ink of the combinations shown in Table 5 were filled in cartridges, respectively, and set in the above ink jet recording apparatus. Using the above ink jet recording apparatus, the first reaction liquid, the second reaction liquid and the ink were applied in this order to the recording medium of the type shown in Table 5. In this operation, the first reaction liquid and the second reaction liquid were applied to separate areas so that they may not overlap each other on the recording medium. As a result, a 5 cm×5 cm solid image formed by applying the first reaction liquid and the ink (low gloss area) and a 5 cm×5 cm solid image formed by applying the second reaction liquid and the ink (high gloss area) were recorded. The recording duty of the first reaction liquid and the second reaction liquid was 50% each and the recording duty of the ink was 160%. The recording environment was a temperature of 25° C. and a relative humidity of 50%. Thereafter, using a gas blowing device, the recorded image was dried by the drying method shown in Table 5. The gas blowing temperature and the gas blowing speed were measured on the recording medium. Table 4 shows the details of the drying method. In each operation, the gas blowing device blew gas to the recording medium from upstream in the conveying direction of the recording medium and in the case where the gas blowing device is provided at a position on the upstream side relative to the recording head in the conveying direction of the recording medium in Table 4, gas blowing was conducted in the horizontal direction from upstream in the conveying direction of the recording medium toward the point right under the recording head 22. After drying, using a heating device, the recorded image was heated at the heating temperature shown in Table 5. In the present invention, “A” and “B” were set as acceptable levels, and “C” was set as an unacceptable level in the evaluation criteria for each item shown below. The evaluation results are shown in Table 6.

The viscosity (Pa·s) of the first mixture obtained by mixing 100 parts of the ink and 7 parts of the first reaction liquid, and the viscosity (Pa's) of the second mixture obtained by mixing 100 parts of the ink and 7 parts of the second reaction liquid were measured. Then, the value of viscosity (Pa·s) of the first mixture/viscosity (Pa·s) of the second mixture (times) was calculated. The calculated values are shown in Table 5.

TABLE 4
Drying Method

| | Gas | Gas | |
|---|---|---|---|
| | Blowing | Blowing | |
| Drying | Temperature | Speed | |
| Method | (° C.) | (m/s) | Details |
| 1 | 30 | 1.5 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 2 | 30 | 1.5 | Gas is blown to the surface of |
| | | | the recording medium from a gas |
| | | | blowing device incorporated at |
| | | | a position downstream of the |
| | | | recording head in the conveying |
| | | | direction of the recording medium |
| | | | to dry it. |
| 3 | 25 | 1.5 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 4 | 60 | 1.5 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 5 | 65 | 1.5 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 6 | 30 | 1.0 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 7 | 30 | 0.5 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 8 | 30 | 10.0 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 9 | 30 | 11.0 | Gas is blown to the surface of |
| | | | the recording medium from a gas |
| | | | blowing device incorporated at |
| | | | a position upstream of the |
| | | | recording head in the conveying |
| | | | direction of the recording medium |
| | | | to dry it. |
| 10 | 40 | — | The back surface of the recording |
| | | | medium is heated and dried with a |
| | | | platen heater. |

TABLE 5
Evaluation Conditions

| | | | | | Viscosity of 1st |
|---|---|---|---|---|---|
| | | | | | Mixture/ |
| | | 1st Reaction | 2nd Reaction | | Viscosity of 2nd |
| | | Liquid | Liquid | Ink | Mixture (times) |
| Example | 1 | 1 | 1 | 1 | 2.3 |
| | 2 | 1 | 1 | 2 | 2.3 |
| | 3 | 1 | 1 | 3 | 2.3 |
| | 4 | 1 | 1 | 4 | 2.3 |
| | 5 | 1 | 1 | 5 | 2.0 |
| | 6 | 2 | 2 | 1 | 2.3 |
| | 7 | 3 | 3 | 1 | 2.3 |
| | 8 | 1 | 1 | 1 | 2.3 |
| | 9 | 1 | 1 | 1 | 2.3 |
| | 10 | 1 | 1 | 1 | 2.3 |
| | 11 | 1 | 1 | 1 | 2.3 |
| | 12 | 1 | 1 | 1 | 2.3 |
| | 13 | 1 | 1 | 1 | 2.3 |
| | 14 | 1 | 1 | 1 | 2.3 |
| | 15 | 1 | 1 | 1 | 2.3 |
| | 16 | 1 | 1 | 1 | 2.3 |
| | 17 | 1 | 1 | 1 | 2.3 |
| | 18 | 1 | 1 | 1 | 2.3 |
| | 19 | 4 | 1 | 1 | 2.0 |
| | 20 | 5 | 1 | 1 | 1.7 |
| | 21 | 1 | 1 | 1 | 2.0 |
| | 22 | 1 | 1 | 6 | 2.0 |
| | 23 | 1 | 1 | 7 | 2.5 |
| Comparative | 1 | 1 | 1 | 8 | 3.0 |
| Example | 2 | 1 | 1 | 9 | 2.3 |
| | 3 | 6 | 4 | 1 | 0.4 |
| | 4 | 1 | 4 | 1 | 1.0 |
| | 5 | 6 | 1 | 1 | 1.0 |
| | 6 | 1 | 1 | 1 | 2.3 |
| | 7 | 1 | 1 | 1 | 2.3 |
| | 8 | 1 | 1 | 1 | 2.3 |

TABLE 5
Evaluation Conditions (continued)

| | | | | Heating |
|---|---|---|---|---|
| | | Recording | Drying | Temperature |
| | | Medium | Method | (° C.) |
| Example | 1 | 1 | 1 | 80 |
| | 2 | 1 | 1 | 80 |
| | 3 | 1 | 1 | 80 |
| | 4 | 1 | 1 | 80 |
| | 5 | 1 | 1 | 80 |
| | 6 | 1 | 1 | 80 |
| | 7 | 1 | 1 | 80 |
| | 8 | 1 | 1 | 50 |
| | 9 | 1 | 1 | — |
| | 10 | 1 | 2 | 80 |
| | 11 | 1 | 1 | 80 |
| | 12 | 1 | 3 | 80 |
| | 13 | 1 | 4 | 80 |
| | 14 | 1 | 5 | 80 |
| | 15 | 1 | 6 | 80 |
| | 16 | 1 | 7 | 80 |
| | 17 | 1 | 8 | 80 |
| | 18 | 1 | 9 | 80 |
| | 19 | 1 | 1 | 80 |
| | 20 | 1 | 1 | 80 |
| | 21 | 1 | 1 | 80 |
| | 22 | 1 | 1 | 80 |
| | 23 | 1 | 1 | 80 |
| Comparative | 1 | 1 | 1 | 80 |
| Example | 2 | 1 | 1 | 80 |
| | 3 | 1 | 1 | 80 |
| | 4 | 1 | 1 | 80 |
| | 5 | 1 | 1 | 80 |
| | 6 | 2 | 1 | 80 |
| | 7 | 1 | — | 80 |
| | 8 | 1 | 10 | 80 |

### (Partial Control of Glossiness)

Two fluorescent lamps arranged at intervals of 5 cm and 10 cm were used as an observation light source, and the fluorescent lamps were projected on the image from a position 2 m away. The shape of the fluorescent lamp projected on the image was visually confirmed under the conditions of an illumination angle of 45° and an observation angle of 45°, and the image clarity of the high gloss area and the low gloss area was evaluated according to the evaluation criteria shown below.
AA: Two projected fluorescent lamps at 5 cm intervals were clearly projected on the image.
A: The edge portions of the two projected fluorescent lamps at 5 cm intervals were blurred, but the boundary was distinguishable.
B: The boundary between the two projected fluorescent lamps at 5 cm intervals was not recognized, but the boundary between the two fluorescent lamps at 10 cm intervals was distinguishable.
C: The boundary between the two projected fluorescent lamps at 10 cm intervals was not recognized.

The “image clarity rank of the high gloss area” and the “image clarity rank of the low gloss area” were compared, and the partial control of glossiness was evaluated according to the evaluation criteria shown below.
A: The image clarity rank of the high gloss area was two ranks higher than the image clarity rank of the low gloss area.
B: The image clarity rank of the high gloss area was one rank higher than the image clarity rank of the low gloss area.
C: The image clarity rank of the high gloss area was the same as or lower than the image clarity rank of the low gloss area.

### (Abrasion Resistance of Low Gloss Area)

Using an abrasion tester (Tester Sangyo Co., Ltd.), which is Rubbing Tester II (Gakushin type) compliant with JIS L 0849, the surface of the recorded image was rubbed back and forth 150 times with a load of 500 g using a white cloth for friction (cotton) specified in JIS L 0803. The image after the friction test was visually confirmed, and the abrasion resistance of the low gloss area was evaluated according to the evaluation criteria shown below.
A: No scratch marks were observed on the image after 150 reciprocations.
B: Scratch marks were observed on the image after 150 reciprocations, but the white background of the recording medium was not visible.
C: Scratch marks were observed on the image after 150 reciprocations, and the white background of the recording medium was visible.

### (Suppression of Bleeding in High Gloss Area)

Using the above ink jet recording apparatus, the first reaction liquid, the second reaction liquid and the ink were applied in the same recording pass to record a fine line with a line width of 4 pixels (input line width: 1/600 inch×4=169 μm) and a recording duty of 200% on the recording medium. Using a personal image quality evaluation system (trade name “Personal IAS”, manufactured by Quality Engineering Associates), the line width of the recorded fine line (measured line width (μm)) was measured. The difference from the input line width was calculated from the following formula (2), and the suppression of bleeding in the high gloss area was evaluated according to the evaluation criteria shown below.

$$Difference from input line width ( μm ) = Measured line width ( μm ) - 169 ( μm ) \qquad ( 2 )$$

A: The difference from the input line width was 120 μm or less.
B: The difference from the input line width was more than 120 μm to 140 μm or less.
C: The difference from the input line width was more than 140 μm.

TABLE 6
Evaluation Results

| | | | Abrasion | Suppression |
|---|---|---|---|---|
| | | Partial | Resistance | of Bleeding |
| | | Control of | of Low | in High |
| | | Glossiness | Gloss Area | Gloss Area |
| Example | 1 | A | A | A |
| | 2 | A | A | A |
| | 3 | A | A | A |
| | 4 | A | A | A |
| | 5 | A | A | A |
| | 6 | A | A | A |
| | 7 | A | A | A |
| | 8 | A | A | A |
| | 9 | A | B | A |
| | 10 | A | B | B |
| | 11 | A | A | A |
| | 12 | A | B | B |
| | 13 | A | A | A |
| | 14 | A | B | A |
| | 15 | A | A | A |
| | 16 | A | B | B |
| | 17 | A | A | A |
| | 18 | A | B | B |
| | 19 | A | A | A |
| | 20 | B | A | A |
| | 21 | A | A | A |
| | 22 | A | B | A |
| | 23 | A | A | A |
| Comparative | 1 | A | C | A |
| Example | 2 | A | C | A |
| | 3 | C | A | A |
| | 4 | C | A | A |
| | 5 | C | A | A |
| | 6 | C | C | A |
| | 7 | A | C | C |
| | 8 | A | C | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074804, filed May 2, 2024, and Japanese Patent Application No. 2025-074251, filed Apr. 28, 2025, which are hereby incorporated by reference herein in their entirety.

What is claimed is:

1. An ink jet recording method for recording an image by ejecting an aqueous ink containing a pigment, a resin particle and a water-soluble organic solvent as well as an aqueous reaction liquid that reacts with the aqueous ink from an ink jet recording head and applying them to a recording medium, the method comprising:
a gas blowing step of blowing gas to the recording medium to reduce liquid components,
wherein the aqueous reaction liquid contains
a first reaction liquid, and
a second reaction liquid having a reaction strength with the aqueous ink lower than that of the first reaction liquid,
the image includes
a low gloss area formed by applying the first reaction liquid and the aqueous ink and
a high gloss area formed by applying the second reaction liquid and the aqueous ink and
the recording medium has a water absorption of 10 mL/m² or less from start of contact to 30 msec^{1/2} in a Bristow method.

2. The ink jet recording method according to claim 1, further comprising a heating step of heating and drying the recording medium at a temperature higher than that of the gas blowing step after the gas blowing step.

3. The ink jet recording method according to claim 1, wherein the gas is blown to the recording medium from upstream in a conveying direction of the recording medium.

4. The ink jet recording method according to claim 1, wherein a gas flow at 25° C. or more to 60° C. or less is blown to the recording medium.

5. The ink jet recording method according to claim 1, wherein a gas flow at 1.0 m/s or more to 10.0 m/s or less is blown to the recording medium.

6. The ink jet recording method according to claim 1, wherein a viscosity (Pa·s) of a first mixture obtained by mixing 100 parts by mass of the aqueous ink and 7 parts by mass of the first reaction liquid is 2.0 times or more in terms of a ratio with respect to a viscosity (Pa·s) of a second mixture obtained by mixing 100 parts by mass of the ink and 7 parts by mass of the second reaction liquid.

7. The ink jet recording method according to claim 1, wherein a cumulative 50% particle diameter based on volume of the resin particle is 180 nm or less.

8. An ink jet recording apparatus used in an ink jet recording method of ejecting an aqueous ink containing a pigment, a resin particle and a water-soluble organic solvent as well as an aqueous reaction liquid that reacts with the aqueous ink from an ink jet recording head and applying them to a recording medium to record an image, the apparatus comprising:
a gas blowing means for blowing gas to the recording medium to reduce liquid components,
wherein the aqueous reaction liquid contains
a first reaction liquid, and
a second reaction liquid having a reaction strength with the aqueous ink lower than that of the first reaction liquid,
the image includes
a low gloss area formed by applying the first reaction liquid and the aqueous ink and
a high gloss area formed by applying the second reaction liquid and the aqueous ink and
the recording medium has a water absorption of 10 mL/m² or less from start of contact to 30 msec^{1/2} in a Bristow method.

9. A set of an aqueous ink and an aqueous reaction liquid used in an ink jet recording method of ejecting an aqueous ink containing a pigment, a resin particle and a water-soluble organic solvent as well as an aqueous reaction liquid that reacts with the aqueous ink from an ink jet recording head and applying them to a recording medium to record an image,
wherein the ink jet recording method includes a gas blowing step of blowing gas to the recording medium to reduce liquid components,
the aqueous reaction liquid contains
a first reaction liquid, and
a second reaction liquid having a reaction strength with the aqueous ink lower than that of the first reaction liquid,
the image includes
a low gloss area formed by applying the first reaction liquid and the aqueous ink and
a high gloss area formed by applying the second reaction liquid and the aqueous ink and
the recording medium has a water absorption of 10 mL/m² or less from start of contact to 30 msec^{1/2} in a Bristow method.
